(19) United States
(12) Patent Application Publication
(10) Pub. No.: US 2006/0260318 A1
(43) Pub. Date: Nov. 23, 2006

(54) Big blast air cannon exhaust system

(75) Inventors: Chunqing Tan, Beijing (CN); Haisheng Chen, Beijing (CN); Huanzhuo Chen, Beijing (CN); Jian Xu, Beijing (CN); Gensheng Zhou, Zhengzhou City (CN); Shuxian Zhou, Zhengzhou City (CN)

Correspondence Address: VENABLE LLP, P.O. BOX 34385, WASHINGTON, DC, 20043-9998, US

(73) Assignees: INSTITUTE OF ENGINEERING THERMOPHYSICS OF CHINESE ACADEMY OF SCIENCES, Beijing (CN); ZHENGZHOU OUYA AIR CANNON Co. Ltd., Zhengzhou City (CN)

(21) Appl. No.: 11/437,017

(22) Filed: May 19, 2006

(30) Foreign Application Priority Data
May 20, 2005 (CN) 200510071134.3

(51) Int. Cl. B05B 1/02

(52) U.S. Cl. 60/770; 239/265.11; 239/601

(57) ABSTRACT

A kind of big blast air cannon exhaust system is published in the invention. The system can joint air cannon pressure tank, other gas container or high pressure transport system through several connection types such as flange connection, weld connection, bolt connection and so on. The big blast air cannon exhaust system in the invention has merits as follows: simple production process, low cost and energy consumption, reliable performance and high impulse force. The stated big blast air cannon exhaust system can be applied for restoring flow of materials that are arching, bridging, rat-holing and clinging in storage bins, bunkers and transport pipes, making materials in containers or pipes flow freely and getting production process continuity. The air cannon can be used in the field of mine and metallurgy industry, building materials industry, chemical industry, mechanical and electrical industry, grain transportation, medicine manufacture, docks and so on.

### RELATED APPLICATION

The present application claims priority on Chinese Application No. 200510071134.3 filed on May 20, 2005, the entire contents and subject matter of which is incorporated herein by reference.

### FIELD OF THE INVENTION

The present invention relates to an air cannon exhaust system. More particularly, the invention relates to a kind of big blast air cannon exhaust system.

### BACKGROUND OF THE INVENTION

The air cannon, which generates powerful impulse force by high speed airstream's momentum caused by momentary burst, can overcome static friction and block stoppage in containers or pipes and activate the discharge of the blocked material again. In the known air cannon exhaust system, high pressure air which flows from the pressure tank through the exhaust system nozzle, can't generate the supersonic flow in the nozzle for that the nozzle inside contour is not a converging-diverging shape. Without analysis and optimum design for the supersonic nozzle, the air flow in the exit section of the exhaust system nozzle is sonic or subsonic, which causes a great reduction in aerodynamic impulse force.

### SUMMARY OF THE INVENTION

The object of the invention is to provide an improved nozzle for the air cannon exhaust system to generate supersonic airflow in the nozzle of the exhaust system which can greatly increase the air flow's momentum and impulse power.

For the object mentioned above, a big blast air cannon exhaust system in the invention consists of an exhaust pipe 5 and a nozzle 6. The inside contour of the said nozzle 6 must be the smooth curve shape which is first gradually converging then gradually diverging. According to this aspect of the invention, the area of inside cross section which is perpendicular to the airflow direction in the stated nozzle is first gradually decreasing and then gradually increasing. According to this aspect of the invention, the shape of the said inside cross section which is perpendicular to the airflow direction in the stated nozzle can be circular shape, rectangular shape, elliptical shape and polygon shape. According to this aspect of the invention, the axis which attaches center points of the said inside cross section in the said nozzle of the air cannon exhaust system can be straight line or curve line. According to this aspect of the invention, the said air cannon exhaust system nozzle can be made of metal materials, non-metallic materials or high polymer materials. According to this aspect of the invention, the said air cannon exhaust system nozzle can be made up of several parts which can be jointed through weld connection or bolt connection.

Further illustratively according to this aspect of the invention, the exhaust system, including an exhaust system flange 4 fixed on the said exhaust pipe 5, can joint air cannon pressure tank flange 3, other gas container or high pressure transport system flange through exhaust system flange 4, as well as through weld connection.

According to this aspect of the invention, the ratio of the maximum area (discharge area) of the inside cross section which is perpendicular to the airflow direction in the stated nozzle 6 to the minimum (throat area) varies from 1.1 to 5.

The big blast air cannon exhaust system in the invention has many merits: simple production process, low cost and energy consumption, reliable performance and high impulse force. The said big blast air cannon exhaust system can be applied for restoring flow of materials that are arching, bridging, rat-holing and clinging in storage bins, bunkers and transport pipes, making materials in containers or pipes flow freely and getting process continuity. The air cannon can be used in the field of mine and metallurgy industry, building materials industry, chemical industry, mechanical and electrical industry, grain transportation, medicine manufacture, docks and so on.

### BRIEF DESCRIPTION OF THE DRAWINGS

FIG. 1a is a structure schematic plan which illustrates one big blast air cannon exhaust system according to the invention;

FIG. 1b is a structure schematic plan which illustrates another kind of big blast air cannon exhaust system according to the invention;

FIG. 2 is a schematic plan which illustrates a big blast air cannon exhaust system according to the invention;

FIG. 3 is a structure schematic plan of an exhaust system nozzle with converging-diverging inside contour shape according to the invention.

### DESCRIPTION OF VIEWS

Noumenon of the pressure tank 1 Pressure tank exhaust pipe 2 Pressure tank flange 3 Exhaust system flange 4 Exhaust pipe 5 Nozzle 6

### DETAILED DESCRIPTION OF THE PREFERED EMBODIMENT

Further Description in detail for the invention with the drawings and operation method is as follows.

### Embodiment 1

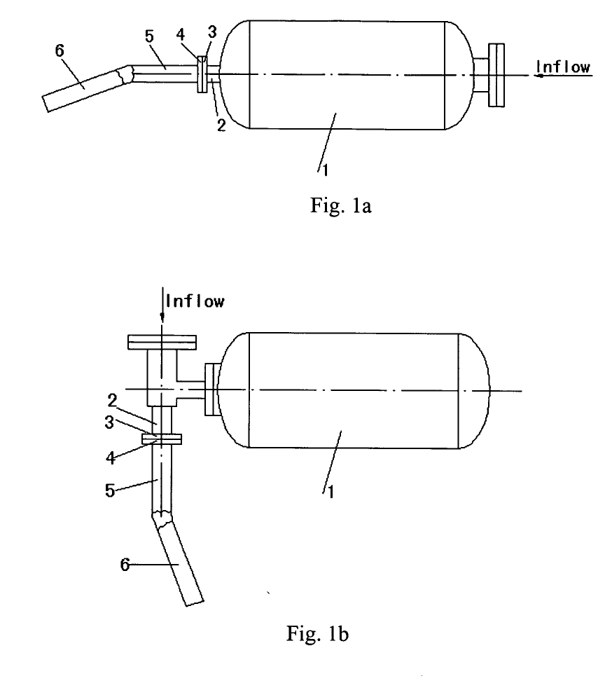

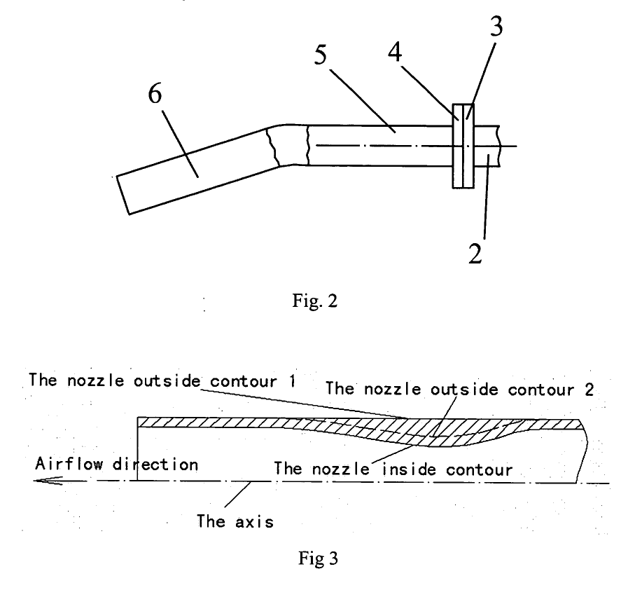

With reference to FIGS. 1a and 1b, an air cannon of high impulse force exhaust system according to the invention, consist mainly of air cannon entity system and an exhaust system. The air cannon system consists mainly of the pressure tank 1, the pressure tank exhaust pipe 2, the pressure tank flange 3 and the valve etc. The exhaust system consists mainly of the exhaust system flange 4, the exhaust pipe 5 and the nozzle 6. For different air cannon entity structure, with reference to FIGS. 1a and 1b, there are two basic forms for the air cannon. FIG. 2 is the installation schematic plan of the big blast air cannon exhaust system according to the invention.

In the embodiment, the air cannon exhaust system joints the pressure tank flange 3, other pressure tank or high pressure transport system through the exhaust system flange 4.

As FIG. 2 shown, the air cannon exhaust system consists of the exhaust system flange 4, the exhaust pipe 5 and the nozzle 6. In actual applications, the length of the exhaust pipe which can be removed if unnecessary depends on the distance between the pressure tank and the blast working surface. Additionally, the exhaust pipe may be straight pipe, bent pipe or compound shape pipe. The inside cross section of the pipe can be discretional shapes, such as rectangular shape, circular shape, elliptical shape, and so on.

FIG. 3 is an amplified structure schematic plan of the exhaust system nozzle with converging-diverging inside contour shape. To get supersonic flow in the nozzle, the inside contour of the nozzle in the air cannon exhaust system must be a smooth curve shape which is first gradually converging then gradually diverging, in other words, it means that the area of inside cross section which is perpendicular to the airflow direction in the nozzle is first gradually decreasing then gradually increasing. Generally speaking, ratio of the maximum of the inside cross section area (discharge area) in the nozzle to the minimum (throat area) varies from 1.1 to 5, while the ratio is 1.5 in the case. On the other hand, to get supersonic flow or not doesn't depend on the outside contour shape of the nozzle, thus, the outside contour can be straight line (the nozzle outside contour 1 shown in the FIG. 3) or curve line (the nozzle outside contour 2 shown in the FIG. 3).

In the case, the inside cross section shape, which is designed for the nozzle of the air cannon exhaust system, is circular shape, and the central line, in detail, the line which attaches center points of the inside cross section in the nozzle of the air cannon exhaust system, is straight line. Additionally, the nozzle of the air cannon exhaust system is made of stainless steel material; and it can be made up of several parts, which can be jointed through weld connection or bolt connection.

### Embodiment 2

In the case, an air cannon exhaust system includes the exhaust pipe 5 and the nozzle 6. The pipe 5 can joint air cannon pressure tank, other pressure vessel or high pressure transport system by weld connection or bolt connection.

There is no need to amply descript the said exhaust pipe 5 which is the same as the pipe in the embodiment1 mentioned above.

The inside contour of the nozzle 6 in the case is a converging-diverging curve shape, namely, the area of the inside cross section which is perpendicular to the airflow direction in the nozzle is first gradually decreasing then gradually increasing. The ratio of the maximum area (discharge area) of the inside cross section in the nozzle to the minimum area (throat area) is equal to 2.3.

The rectangular shape (or other free shapes such as triangular shape, pentagonal shape, hexangular shape and elliptical shape) can be chosen to design the inside cross section which is perpendicular to the airflow direction in the nozzle of air cannon exhaust system. The axis which attaches center points of the inside cross section in the nozzle of the air cannon exhaust system can be curve. Additionally, the air cannon exhaust system nozzle can be made of stainless steel material, other metal materials, non-metallic materials or high polymer materials as long as the material can satisfy strength requirement of the pressure vessel.

The patent protection of the subject application is not be limited to the specific embodiments, and one of ordinary skill in the art would get variables of the subject application which are under the scope of the subject application.

We claim:

1. A kind of big blast air cannon exhaust system, including the exhaust pipe (5) and the nozzle (6), has characteristics as follows: the inside contour of the said nozzle (6) is a curve shape which is first converging then diverging gradually.

2. According to the big blast air cannon exhaust system stated in claim 1, the area of the inside cross section which is perpendicular to the airflow direction in the stated nozzle (6) first decreases then increases gradually.

3. According to the big blast air cannon exhaust system stated in claim 2, the inside cross section which is perpendicular to the airflow direction in the nozzle can be circular shape, rectangular shape, elliptical shape, triangular shape, pentagonal shape, hexangular shape.

4. According to the big blast air cannon exhaust system stated in claim 3, the axis, which attaches centers of the inside cross section perpendicular to the airflow direction in the nozzle of the air cannon exhaust system, can be straight line or curve line.

5. According to the big blast air cannon exhaust system stated in claim 4, the air cannon exhaust system nozzle can be made of metal materials, non-metallic materials or high polymer materials.

6. According to the big blast air cannon exhaust system stated in claim 5, the air cannon exhaust system nozzle can be made up of several parts which can be jointed through weld connection or bolt connection.

7. According to the big blast air cannon exhaust system stated in claim 1, the exhaust system, including the exhaust system flange (4) fixed on the exhaust pipe (5), can joint air cannon pressure tank flange (3), other air reservoir or high pressure transport system flange through the exhaust system flange (4).

8. According to the big blast air cannon exhaust system stated in claim 1, the exhaust system can joint air cannon pressure tank, other air reservoir or high pressure transport system through weld connection or bolt connection.

9. According to the big blast air cannon exhaust system stated in claim 2, the ratio of the maximum area of the inside cross section in the nozzle (6) to the minimum area varies from 1.1 to 5.
